(19) United States
(12) Patent Application Publication
(10) Pub. No.: US 2026/0246486 A1
(43) Pub. Date: Aug. 20, 2026

(54) METHODS FOR ENERGY-EFFICIENT TRANSMITTER OPERATION AND RELATED-RECEIVER OPERATION

(71) Applicant: INTERDIGITAL PATENT HOLDINGS, INC., Wilmington, DE (US)

(72) Inventors: Paul Marinier, Brossard (CA); Virgil Comsa, Montreal (CA); Moon IL Lee, Melville, NY (US); Faris Alfarhan, Montreal (CA); Senay Negusse, Montreal (CA)

(73) Assignee: INTERDIGITAL PATENT HOLDINGS, INC., Wilmington, DE (US)

(21) Appl. No.: 19/102,105

(22) PCT Filed: Aug. 7, 2023
(86) PCT No.: PCT/US2023/029599

§ 371 Date: Feb. 7, 2025

Related U.S. Application Data
(60) Provisional application No. 63/396,060, filed on Aug. 8, 2022.

(51) Int. Cl. H04B 1/04; H04B 1/401; H04L 5/00; H04W 24/08; H04W 72/23

(52) U.S. Cl. CPC H04B 1/0475; H04B 1/401; H04L 5/0048; H04W 24/08; H04W 72/23; H04B 2001/0425

(57) ABSTRACT

A method for a WTRU can include receiving configuration information including linearity states associated with at least one reference signal (RS), receiving at least one RS, determining at least one linearity setting for the received at least one RS, reporting at least one linearity metric relating to at least one measurement of the received at least one RS, receiving an indication to use a first one of the linearity states for receiving a downlink (DL) transmission, and receiving the DL transmission using the determined linearity setting for an RS of the received at least one RS associated with the indicated first one of the linearity states.

### CROSS-REFERENCE TO RELATED APPLICATIONS

This application claims the benefit of U.S. Provisional Application No. 63/396,060, filed Aug. 8, 2022, the contents of which are incorporated herein by reference.

### BACKGROUND

In wireless communications it is desirable to minimize, or reduce, network power consumption transmission and reception. Such reduction is beneficial for reducing operational costs and environmental sustainability.

Compared to earlier systems, the design of 5G NR is very efficient from the perspective of minimizing transmissions from the network when there is no data to be communicated. For example, always-on cell-specific reference signals (CRS) are not used in 5G NR. However, there is still potential for energy consumption reduction. For example, the network still consumes energy when not transmitting from other activities such as baseband (digital) processing for reception or beamforming. Such “idle” power consumption is not negligible in dense networks even when no WTRU is served during a given period. If the network could turn “off” these activities when not transmitting to a WTRU, energy consumption could be reduced.

### SUMMARY

An effective way of reducing network energy consumption is to reduce the power amplifier (PA) power or the associated bias current, especially since the PA can account for the highest percentage of energy consumption of a gNB. One issue, though, that can come from either operating at a low bias current or at a point above its saturation point is non-linear intermodulation by-products. Allowing the PA to operate without such non-linear components may considerably improve power efficiency of the PA, thus reducing power and energy waste and dissipated heat. This disclosure describes embodiments for enabling the PA to operate in a more power efficient manner, including methods related to reduction of non-linearity impairments by compensating using digital pre-distortion (DPD) at the transmitter and/or digital post-distortion (DPoD) at the receiver.

A method may comprise receiving information regarding a first linearity reference signal, a first linearity state associated with the first linearity reference signal, and a first quasi-colocated reference signal. The method may comprise determining a first linearity setting applicable to the first linearity state and the first quasi-colocated reference signal. The first linearity setting may correspond to parameters for a digital post-distortion (DPoD). The method may comprise receiving information regarding a second linearity reference signal, a second linearity state associated with the second linearity reference signal, and a second quasi-colocated reference signal. Each of the first and second quasi-colocated reference signals may be a channel state information reference signal (CSI-RS) or a synchronization signal block (SSB). The method may comprise determining a second linearity setting applicable to the second linearity state and the second quasi-colocated reference signal. The method may comprise reporting whether a minimum performance is met with the first linearity setting or the second linearity setting. The method may comprise receiving an indication of the first linearity state and the associated first quasi-colocated reference signal or the second linearity state and the associated second quasi-colocated reference signal applicable to a physical downlink control channel (PDCCH) reception or physical downlink shared channel (PDSCH) reception. The method may comprise receiving information over a PDCCH or PDSCH using the first linearity setting on a condition that the indication is for the first linearity state and the associated first quasi-colocated reference signal. The method may comprise receiving information over a PDCCH or PDSCH using the second linearity setting on a condition that the indication is for the second linearity state and the associated second quasi-colocated reference signal.

A method for a WTRU may comprise receiving configuration information including linearity states associated with at least one reference signal (RS), receiving at least one RS, determining at least one linearity setting for the received at least one RS, reporting at least one linearity metric relating to at least one measurement of the received at least one RS, receiving an indication to use a first one of the linearity states for receiving a downlink (DL) transmission, and receiving the DL transmission using the determined linearity setting for an RS of the received at least one RS associated with the indicated first one of the linearity states.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows IMD3 tones position relative to M1/M2 pilots;

FIG. 3 shows an example of a WTRU receiving a reference signal and adjusting a receiver configuration to compensate for distortions measured on a reference signal; and

FIG. 4 shows an example of a WTRU receiving at least one reference signal, reporting linearity metrics related to the at least one reference signal, receiving at least one linearity state, and applying at least one linearity setting associated with the at least one linearity state.

### DETAILED DESCRIPTION

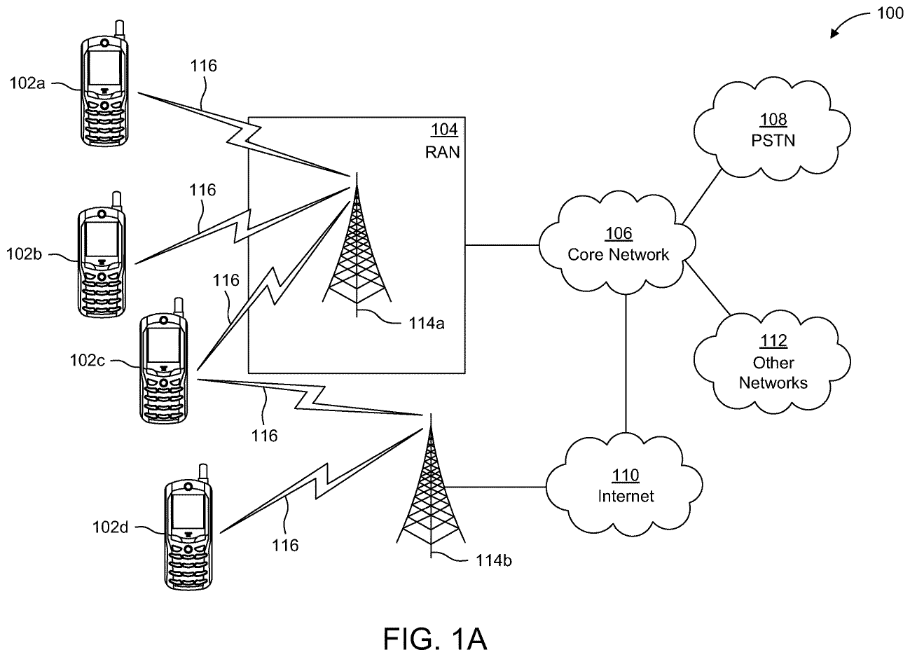

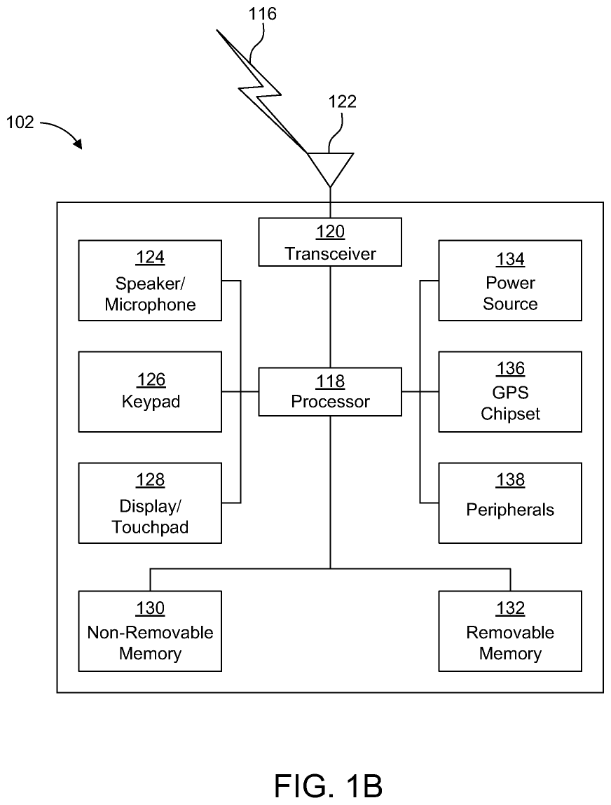

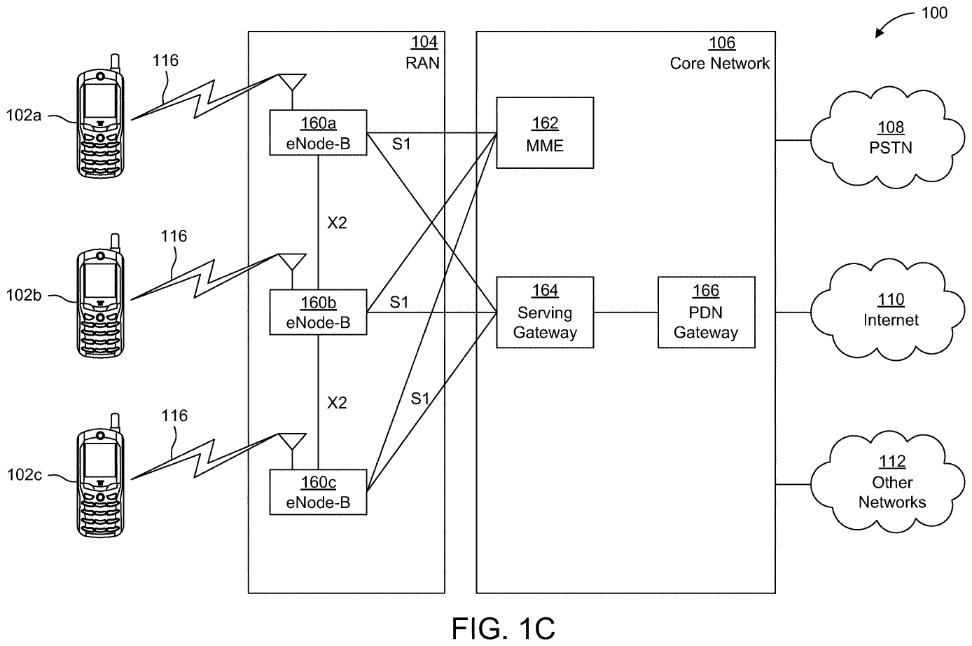

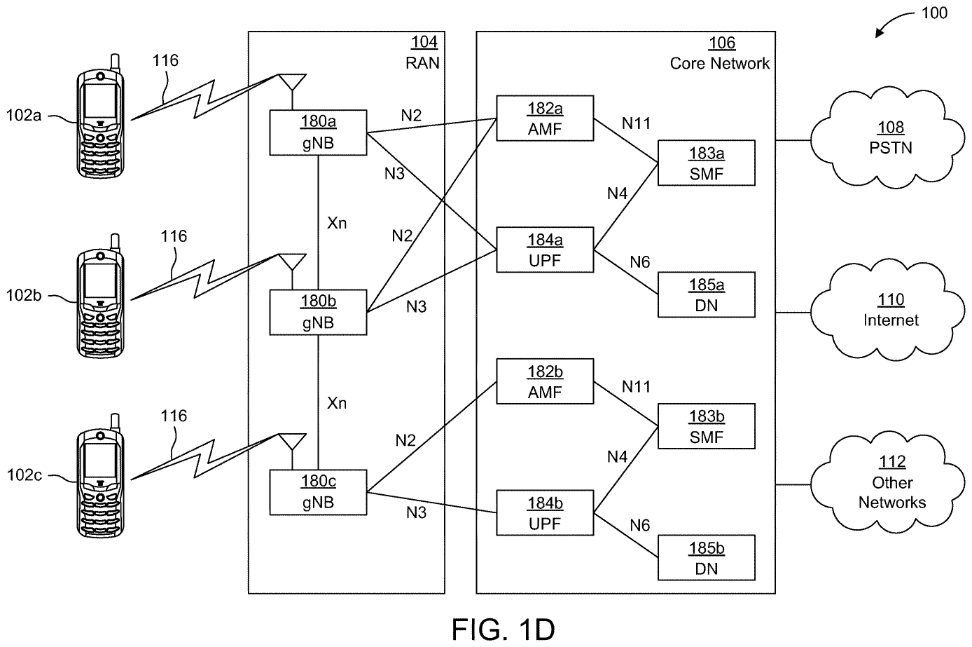

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or to communicate in a wireless environment. By way of example, the WTRUs 102a, 102b, 102c, 102d, any of which may be referred to as a station (STA), may be configured to transmit and/or receive wireless signals and may include a user equipment (UE) such as a WTRU, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE (e.g., WTRU) IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LTE Long Term Evolution e.g. from 3GPP LTE R8 and up
NACK Negative ACK
NES Network Energy Savings
MCS Modulation and Coding Scheme
MIB Master Information Block
MIMO Multiple Input Multiple Output
NR New Radio
OFDM Orthogonal Frequency-Division Multiplexing
PHY Physical Layer
PID Process ID
PEI Paging Early Indication
PO Paging Occasion
PRACH Physical Random Access Channel
PSS Primary Synchronization Signal
RA Random Access (or procedure)
RACH Random Access Channel
RAN Radio Access Network
RAR Random Access Response
RCU Radio access network Central Unit
RF Radio Front end
RLF Radio Link Failure
RLM Radio Link Monitoring
RMSI Remaining system information
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SI System Information
SIB System Information Block
SRS Sounding Reference Signal
SS Synchronization Signal
SSB Synchronization signal block
SSS Secondary Synchronization Signal
SWG Switching Gap (in a self-contained subframe)
SPS Semi-persistent scheduling
SUL Supplemental Uplink
SN Secondary node
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)
3GPP Third Generation Partnership Project

NR supports beamforming with many ports (up to 64 transmit and receive ports) and the energy consumption increases with the number of ports utilized. The utilization of a maximum number of ports may not be necessary for all WTRUs in practice. If the network could adapt the number of ports to only what is required, energy consumption could be reduced.

NR R18 network energy savings aims to improve the operation of the cellular eco-system to enable more efficient adaptation of network transmission and reception resources in the time, frequency, spatial, and power domains, with potential support, feedback, and assistance from an WTRU. This enables an echo-friendly WTRU operation that allows deployment of greener network deployments that allow reduced emissions and Apex costs of operating cellular networks. Unlike LTE, NR does not require transmission of always-on synch or reference signals and supports adaptable bandwidth and MIMO capabilities. While initial work in R18 is expected to not impact legacy WTRUs, it is anticipated that such adaptation of network resources will enable greater efficiency in operating newer deployments and later generations.

The following terminology may be used and may be assumed through this disclosure. Channel state information (CSI) may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI), and/or any other measurement quantity measured by the WTRU from the configured CSI-RS or SS/PBCH block. Uplink control information (UC) may include: CSI, HARQ feedback for one or more HARQ processes, scheduling request (SR), link recovery request (LRR), CG-UCI and/or other control information bits that may be transmitted on a PUCCH or PUSCH. Channel conditions may refer to any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g. RSRP, RSRQ), an RLM state, and/or channel availability in unlicensed spectrum (e.g. whether the channel is occupied based on determination of an LBT procedure or whether the channel is deemed to have experienced a consistent LBT failure. PRACH resource may refer to a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.

A property of scheduling information (e.g., an uplink grant or a downlink assignment) may comprise at least one of the following: a frequency allocation; an aspect of time allocation, such as a duration; a priority; a modulation and coding scheme; a transport block size; a number of spatial layers; a number of transport blocks to be carried; a TCI state or SRI; a number of repetitions; and whether the grant is a configured grant type 1, type 2 or a dynamic grant.

An indication by DCI may comprise of at least one of the following: an explicit indication by a DCI field or by RNTI used to mask CRC of the PDCCH, or an implicit indication by a property such as DCI format, DCI size, Coreset or search space, aggregation level, identity of first control channel resource (e.g., index of first CCE) for a DCI, where the mapping between the property and the value may be signaled by RRC or MAC.

The terms network availability state and NES state may be used interchangeably.

A WTRU may determine whether it may transmit or receive on certain resources depending on a network availability state, which implies the gNB's power savings status. An availability state may correspond to a network energy savings state or a gNB activity level. An availability state may be uplink or downlink specific, and may change from symbol to symbol, slot to slot, frame to frame, or on longer duration granularity. The availability state may be determined by the WTRU or indicated by the network. An availability state may be, for example, “on”, “off”, “dormant”, “micro sleep”, or “deep sleep”. Such states may be abstracted by network configuration parameters and/or values. The “off” availability state may imply that the gNB's baseband hardware is completely turned off. The “sleep” availability state may imply that the gNB wakes up periodically to transmit certain signals (e.g., presence signals, synchronization, or reference signals) or receive certain uplink signals. In some availability states, some DL or UL resources are not available during certain periods of time, and this may enable the network to turn off baseband processing and other activities. Some measurement resources (e.g., SSBs or CSI-RS) may only be made available in certain availability states.

Under certain conditions, a WTRU may further transmit a request to the network (i.e., wake-up request) to modify the availability state to a state for which resources that would satisfy WTRU requirements are available. Such a wake-up request may comprise a transmission that may be decodable by a low-complexity receiver at the gNB for which an energy consumption requirement is minimal. Herein, wake up request, turn on request, or switch on WTRU assistance information may be used interchangeably. In certain availability states (e.g., “micro sleep” or “deep sleep”), a wake up request may be exclusively used and may refer to a physical uplink signal transmitted by the WTRU to request a change of availability state. A switch on request may otherwise be a physical layer or an L2 indication from the WTRU to the network, which may be delivered as a MAC CE, UCI, RRC signaling, PUCCH, or RACH indication, and may include switch on WTRU assistance information and/or a positioning report.

A WTRU may determine an availability state from reception of an availability state indication from, for example by L1/L2 signaling (e.g., a group common DCI or indication), or implicitly determine it form the reception of periodic DL signaling or lack thereof. The WTRU may determine if a resource is available for transmission/reception and/or measurements for the determined network availability state if it is applicable in the active availability state.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part.

A WTRU may consider the active availability state associated with a cell, carrier, TRP, or frequency band to be “off”, “deep sleep”, or “micro sleep” after reception of a downlink signaling that changes the cell's or TRP's availability state. For example, the WTRU may receive a turn-off command on broadcast signaling, RRC signaling, DCI (e.g., a group common DCI), or a DL MAC CE. The WTRU may determine an availability state from reception of availability state indication from, for example by L1/L2 signaling (e.g., a group common DCI or indication).

A WTRU may implicitly assume a certain availability state associated with a cell, carrier, TRP, or frequency band (e.g., “off”, “deep sleep”, “micro sleep” or “dormant”) from at least one of the following.

A WTRU may implicitly assume a certain availability state based on reception of a command or signal indicating a change in availability state (e.g., a group common DCI in connected mode or RRC signaling). The WTRU may determine an availability state implicitly form the reception of periodic downlink signaling. The WTRU may be configured or specified to associate an availability state with one or more downlink signal types (e.g., SSB, partial SSB, and/or one or more periodicity).

A WTRU may implicitly assume a certain availability state based on a gNB DTX status (e.g., whether the gNB is in active time or an associated activity timer is running).

A WTRU may implicitly assume a certain availability state based on a lack of detection of a presence indication. The WTRU may determine an availability state associated with the cell (e.g., “off” or “deep sleep”) if a presence indication was not detected on one or more presence indication occasions. The WTRU may assume or change a cell's availability state after a number of consecutive misdetections or after a period of time (e.g., a timer) expires following no detection of a presence signal. The WTRU may determine an availability state is active or de-active after expiration of a time period (e.g., a timer) associated with the availability state. The WTRU may determine an availability state implicitly from the lack of reception of periodic downlink signaling. For example, the WTRU may be configured with a signal quality threshold (e.g., an RSRP threshold) and if the WTRU does not detect a signal associated with an availability state (e.g., a presence signal or an SSB) with a signal strength above a threshold, then the WTRU may assume that this availability state is not active and may assume a different availability state. This criterion may be also coupled with a lack of detection of an identifying sequence of the presence signal (e.g., detection of the PSS sequence for example).

A WTRU may implicitly assume a certain availability state based on a time of day. The WTRU may be configured to automatically assume a certain availability state (e.g., off, sleep, or dormant) for a configured subset of cells (e.g., capacity boosting cells) depending on the time in the day. For example, the WTRU may determine that a capacity boosting cell has an availability state as “on” in certain hours of the day, “deep sleep” in other configured hours, and “off” in a third set of configured hours of the day or night.

A WTRU may implicitly assume a certain availability state based on the availability state of an associated cell (e.g., another carrier of the same MAC entity, another carrier in the same cell group, another carrier in the same gNB, another sector in the same gNB, or a configured associated cell or capacity boosting cell).

A WTRU may implicitly assume a certain availability state based on detection of a PSS only signal or a simplified/stripped down SSB signal.

A WTRU may implicitly assume a certain availability state based on detection of an RS signal (e.g., CSI-RS, PRS, TRS) or the lack thereof.

A WTRU may implicitly assume a certain availability state based on the WTRU's RRC state (Idle, inactive, or connected mode).

A WTRU may implicitly assume a certain availability state based on whether paging has been received, possibly within a configured time window.

A WTRU may implicitly assume a certain availability state based on whether system information (e.g., periodic SI or a subset of SIBs) have been received, possibly within a configured time window.

A WTRU may be configured to monitor an indication that may characterize the level of network activity (e.g., an availability state). The network activity may be associated with a gNB and/or a cell. The WTRU may assume the same availability state for all cells that are part of the same gNB (e.g. cells of the same MAC entity). The network activity indication (e.g., the presence indication) may comprise a channel (e.g., a PDCCH) and/or a signal (e.g., a sequence). The activity indication may indicate the level of activity the WTRU may expect from the associated gNB and/or cell (e.g., reduced activity). The activity indication may comprise activity information of other gNBs or cells. The activity indication may be a PDCCH comprising group common signaling. For example, the network may transmit a group common DCI to a group of WTRUs (e.g., WTRUs in the serving cell) indicating a change of an activity state or activity level in uplink and/or downlink. The CRC of the PDCCH may be scrambled with a dedicated “activity indication RNTI.” A WTRU may be configured with at least one search space associated with the monitoring occasions of the activity indication PDCCH. The indication may comprise a go-to-sleep signal (e.g., a predefined sequence). When the WTRU detects this sequence, the WTRU may expect a reduced activity level over a specific time duration. The WTRU may activate C-DRX for the period of time indicated. Alternatively, two sequences may be used to indicate regular activity and reduced activity.

The signaling within the PDCCH or the activity indication may comprise at least one of the following.

The signaling within the PDCCH or the activity indication may comprise an expected activity level of the associated gNBs or cells over a specific time interval (e.g., an availability state). The activity levels may be predetermined and/or configured and may, for example, comprise regular and reduced activity. The signaling may indicate the activity level. For example, a bit “1” may indicate regular activity and a bit “0” may indicate reduced activity.

The signaling within the PDCCH or the activity indication may comprise for each activity level (e.g., availability state), transmission and reception attributes may be defined. For example, during reduced activity, a WTRU may not be expected to monitor certain PDCCH search spaces (including all SSs), and/or receive a certain type of PDSCH (including all PDSCH), and/or transmit PUCCH/PUSCH, and/or perform certain measurements.

The signaling within the PDCCH or the activity indication may comprise a set of configurations that may be associated with an activity level and may be used/applied when that activity level is indicated, for example, SS configurations, CSI reporting configurations, indices of transmitted SSBs, etc. Each set of configurations may have an attribute associated with an activity level, for example, a tag that can be set to “reduced activity”.

The signaling within the PDCCH or the activity indication may comprise the time interval over which an activity level is assumed may be signaled in the PDCCH or part of the activity indication. The time interval may be indicated using a bitmap where each bit in the bitmap may be associated with a specific duration (e.g., a slot or a frame). For example, a bit “1” may indicate regular activity and a bit “0” may indicate reduced activity on an associated frame. The time interval may be indicated with a start time and length of interval. The start time may be defined, for example, it may be determined by adding a fixed offset to the time the indication is received. The length of the interval may be configured or signaled in the indication PDCCH.

The signaling within the PDCCH or the activity indication may comprise the time interval over which an activity level is assumed may be predetermined.

A WTRU may be configured or predefined with an alternate serving cell to perform initial access, mobility, or cell reselection on in the event the current serving cell or a capacity boosting cell is turned off or another certain condition is met. The WTRU may be configured per broadcast for dedicated signaling with a list of fallback or alternate serving cells, possibly per serving cell or per gNB. For example, the WTRU may initiate a cell reselection or mobility procedure to an alternate serving cell associated with a cell or gNB from which a turn-off indication was received. In an example, the turn-off or go-to-sleep indication may dynamically indicate to the WTRU to which cell to fallback or to connect (e.g., by dedicated or broadcast signaling). In an example, the fallback cell may be predefined as the master node cell if the WTRU is in dual connectivity. The fallback/alternate cell may be configured or predefined to be a cell associated with a different RAT or frequency band. For example, the WTRU may fallback to an LTE or to an FR1 cell associated with the cell or gNB from which the turn-off indication was received (e.g., if the WTRU is in CA or DC using multiple RATs or multiple frequency bands).

A WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals only in a subset of network availability states (e.g., SRS, pSRS, PRACH, UCI).

One approach for network energy saving is for the gNB to reduce the bias current of the power amplifier (PA). However, reducing the bias current may have the effect of increasing the non-linear response of the amplifier. The impairments caused by non-linearities may be compensated by digital pre-distortion (DPD) at the transmitter and/or digital post-distortion (DPoD) at the receiver. It is proposed that the WTRU provide feedback to the gNB to assist in setting the DPD. It is also proposed that the WTRU support DPoD to compensate for in-band distortions.

Impairments from operating a base station's PA in its non-linear region may include intermodulation distortion products, including 3^{rd} order, 5^{th} order, and 7^{th} order products. Non-linearity impairments may be proportionally with the PA power, and additional input power to the PA may go more into impaired modulation by products than into the modulated subcarriers, especially at signal amplitudes closer to the PA saturation point. Such impairments may cause the PA to operate in a power-inefficient manner, where much of the consumed PA energy is wasted and also causes system degradation due to carrier leakage out of band. Much of the additional power may also be dissipated as heat that causes additional non-linearity in the PA operation. The network may compensate for such impairments by applying DPD.

If the network varies the bias current of the power amplifier and/or the corresponding DPD setting for a transmitter, the amount of distortion observed at the receiver, and consequently the required setting of the DPoD, may also vary. It may be complex or unfeasible for the WTRU to properly adapt its DPoD and maintain its receiver performance with existing procedures.

The following example procedures enable a WTRU to maintain its receiver performance when operating in a system where the distortion characteristics of the transmitted signal are subject to variations.

In an embodiment, a WTRU may receive a reference signal and adjust the configuration of its receiver to compensate for the distortions measured on the reference signal. For example, the WTRU may set parameters of a digital post-distortion (DPoD) module. The WTRU may also receive an indication of the state of the transmitter that generated the reference signal in terms of its linearity characteristics. Such state may be referred to as a “linearity state”. The linearity state may be associated to transmitter implementation aspects such as at least an amount of current feeding a power amplifier, a particular digital pre-distortion setting, a transmission power, and an antenna beam. Once the WTRU has successfully adapted its receiver to correct non-linearities resulting from a particular transmitter configuration summarized by a linearity state, the WTRU may reuse the same receiver configuration for subsequent transmissions with the same linearity state. The WTRU may reuse the same receiver configuration only if both the linearity state and the spatial filter (as identified by, for example, a Transition Configuration Indicator (TCI) state) are the same.

Alternatively, the linearity state of the transmitter may be assessed by the WTRU using measurements of specific inter-modulation products caused by the transmitter non-linearity under certain conditions that are further described below.

A WTRU may quantify the linearity state by measuring the difference in power level, amplitude, and/or phase of the linearity RS and the measurement on the tone corresponding to the intermodulation by product of a certain order.

Digital pre-distortion (DPD) algorithms are based on the one or two loopbacks that use the amplifier output feedback to verify the linearity of the amplifier in amplitude and phase. In the modern multi-panel and active antenna systems (AASs) where there are multiple amplifiers integrated with antenna elements, the linearity becomes a more complicated problem to resolve. The beams are created by coherently combining a set of amplifiers and panels with different input weights and then each amplifier may bring its own imperfection into the final transmitted signal. During field operation, a re-calibration of an AAS may be a difficult task. Under these considerations, the DPD algorithms may need external feedback to correct such additive distortion effects from multiple amplifiers and on multiple beams.

A potential embodiment may be to have a WTRU feedback a signal-linearity measurement to the network (i.e., base station), for example, based on measuring a training reference tone signal(s) and/or associated byproducts.

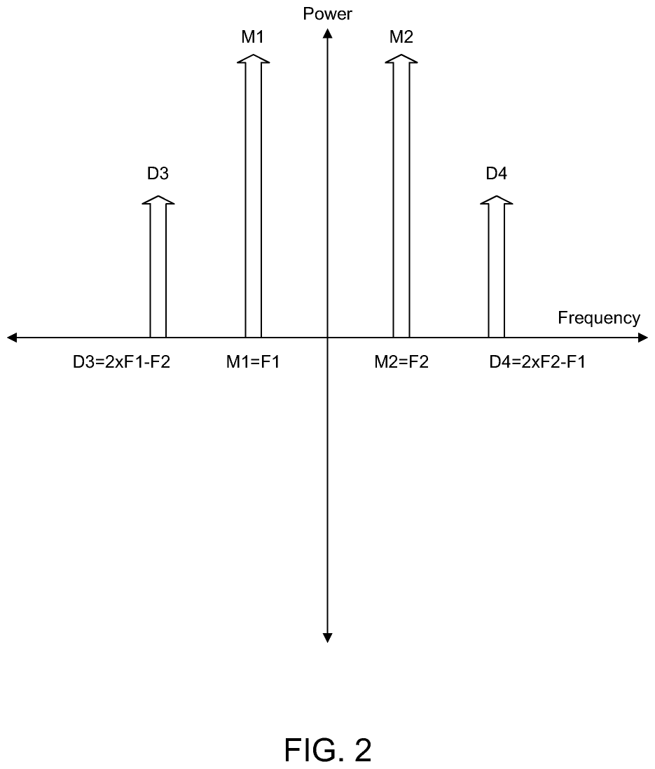

A method for measurement of linearity may be the measurement of third-order intermodulation products D3 and D4 and have a pair of tones (RS) that we may call RS1(M1) and RS2(M2) close enough in a frequency domain so M1, M2, D3, D4 fall within the band and measurement channel of the WTRU. FIG. 2 shows the M1, M2, D3, D4 relation in a frequency domain. The frequencies of intermodulation byproducts (or a subset thereof) may fall within the WTRU's measurement band, while a second subset may fall out of the WTRU's measurement band (e.g., out of the WTRU's bandwidth part (BWP)). The WTRU may measure such byproducts that fall within the WTRU's active BWP.

The M1 and M2 tones may be selected to be close enough from each other so the third inter-modulation product may be close enough to fall within the measurement channel of the device.

For example, if M1=F1 and M2=F2 where F1 and F2 may be located at the NR sub-carriers' level of the channel selected numerology, then D3 and D4 may be located at the following locations: D3(F1, F2)=2F1-F2 and D4(F1, F2)=2F2-F1.

In an embodiment, a base station may configure a set of pairs of tones in a frequency domain that may cover a certain bandwidth that may be measurable by a WTRU. Also, the measurement configuration may be accompanied by a time-domain gap that will allow for D3, D4 intermodulation products detection in better conditions.

Alternatively, to avoid a gap, the base station may puncture everything (i.e., data carrying REs) around the REs that are located at the D3, D4 locations for each M1, M2 tone pairs.

In an embodiment, the M1, M2 signals may be a scrambled sequence (RS type) that may be detected without creating any specific gap. The sequence may be configured or determined from a cell property (e.g., the PCI or the SSB indices). The D3, D4 products may be detected and measured in certain conditions or by puncturing everything around D3, D4 locations in the frequency domain.

In terms of PA linearity, the ratio between (M1,M2) and the (D3,D4) measured powers may be the qualifier. For example, a below X dB differential power between these two measurements may be an indication of an unacceptable non-linearity level of the base station PA. For example, a WTRU may feedback the difference between M1 and D3 and the difference between M2 and D4 to the gNB in dB. The WTRU may further feedback the difference for 5^{th}-order byproducts in some conditions, for example, when they are in band or if the difference between M1 and D3 is larger than a threshold or if the difference between the 3^{rd}-order and 5^{th}-order tones is larger than a dB threshold.

Such a measurement of (D3, D4) type may need to be performed over a burst of (M1, M2) type of signals and averaged accordingly. A burst may be required to accumulate more measurement power and have a better assessment of the (D3, D4) presence. For example, a WTRU may report the difference between non-linearity metrics for a successive set of measurement training tones. The WTRU may report the difference between (M1-D3) gaps for two successive training tones and/or indicate the preference in terms which tone results in a lower gap.

Upon detection of a non-linearity condition through measurements, a WTRU may be configured to report the measurement. As such, this measurement may be configured to be reported or triggered based on an (M1, M2)/(D3, D4) type ratio threshold. The measured quantity may be in dB ratio referenced to (M1, M2) or an absolute value of (D3, D4) expressed in dBm.

The measurement may be semi-statically configured and activated by a MAC-CE or DCI order. For example, a semi-persistent measurement of the non-linearity measurement may be activated/de-activated by a MAC CE. For each occasion, a burst of measurement pilots may be generated by the base station. In this case, the measurement may be reported in absolute values (dB or dBm) or as an indicator linear/non-linear.

To perform a such measurement, a WTRU may have to be in a connected mode. The measurement may be initiated on a specific beam that may be a WTRU serving beam. Alternatively, the WTRU may be ordered to perform a measurement per beam on a group of beams that may be a sub-group of beams that are already reported by the WTRU. These measurements may be in order in a time division order and may require gaps for the non-serving beams. There may be a limited number of linearity measurements that the WTRU may perform and thus a system-wide approach may be required.

Alternatively, a one-shot measurement may be configured. This may be activated by a DCI and reported as an absolute value or as an indicator linear/non-linear based on the measurement result versus linearity threshold.

The signal design may follow a ZP-CSI-RS and NZP-CSI-RS model, and thus the WTRU assumptions for NZP-LIN-Mi-RS and ZP-LIN-Mi-RS pairs and for a ZP-LIN-Di-RS pair can be clear and can avoid collisions with other transmissions. There may be multiple Mi and Di pairs depending on the WTRU channel bandwidth.

The ZP-LIN-Mi-RS pairs and ZP-LIN-Di-RS pair may need to be configured in the neighboring cells or beams that are overlapping with the measured cell/beam linearity. The configured measurement signals and locations may be beam specific and linked to a TCI state.

When multiple measurement pairs are configured in a beam, a WTRU may report the most significant non-linearity. Alternatively, an averaged value of the linearity measurements may be reported. In an example, the WTRU may report the most significant value and differential values for the rest of the measured pairs.

Alternatively, a WTRU may report as a sub-band non-linearity for each sub-band or designated sub-band related pair.

In an example, the network may configure a set of Mi pairs per carrier/beam and a WTRU may be ordered to perform measurements on only one pair or a sub-set of pairs.

When intra-band carrier aggregation is configured along with non-linearity measurements, the linearity tones/RS for measurement may span a carrier, or two or more carriers depending on a base station decision and its RF front end architecture.

In an embodiment, a base station may apply pre-distortion to the transmitted signal according to the nonlinear property measured/detected and reported by a WTRU. The pre-distortion method may be based on a look-up table (LUT) where different vectors, which describe the nonlinear characteristics of the PA for various amplitude levels, may be available/stored based on measurements. In an example, measurements for a LUT may be done employing RSs during initial access procedures and feedbacks provided by the WTRU. The gNB may also periodically update the LUT according to changes in allocated BWP and/or a transmitted signal's PAPR value, for example. The WTRU may feedback, to the gNB, the vectors used to reduce the non-linearity metrics of the received signal.

A WTRU may use one of the following embodiments to determine the linearity state applicable to a certain reception.

In an embodiment, a linearity state index may be indicated implicitly or explicitly in a DCI associated with the reception. For example, a new field may indicate the linearity index.

In an embodiment, a linearity state index applicable to a configured grant may be configured as part of the configured grant configuration.

In an embodiment, a linearity state may be indicated by a MAC CE. For example, the MAC CE may indicate an association between a linearity state and a TCI state. Upon receiving a PDCCH or PDSCH, a WTRU may set its receiver according to the linearity state associated to the TCI state applicable to the PDCCH or PDSCH. In an embodiment, a linearity state index may be configured by RRC as part of an extended TCI state.

In an embodiment, the WTRU may determine the linearity state from measuring a reference training tone, and/or associated byproducts (e.g., if intermodulation by products are measured with strength above a threshold or if they are within a certain dB from the levels of the received reference tones).

In an embodiment, a WTRU may be configured to perform measurements over RSs assigned to measure a linearity property of the received signal. The linearity property may indicate the level of non-linearity introduced on the transmitted/received signal because of distortions arising from the PA and/or other active components in the transmitter/receiver chain. Other types of distortions that are introduced on the signal can be considered severe but may not be nonlinear. These distortions maybe because of multiplicative noise, such as phase noise arising from oscillators during up/down conversion, and/or additive noise, such as channel noise. A distortion that introduces new spectral components, which did not originally exist in the signal, is a nonlinear distortion. The new spectral components may appear within the band and/or out of the band of the signal. The WTRU may be configured with a dedicated RS for measuring/detecting nonlinearity arising from the PA and another RS for measuring distortions arising from other impairments (e.g., phase noise).

In an example, a WTRU may be configured to measure and/or look for spectral regrowth (e.g., in band/inter band intermodulation) to determine linearity/nonlinearity of the transmitted signal. The level and location of the measured spectral regrowth may be used as an indication of the degree of linearity/nonlinearity of the transmitted/received signal. The larger the level of the measured spectral regrowth, the lower/higher the degree of linearity/nonlinearity of the signal.

In an example where the channel condition may be assumed to be favorable (e.g., flat fading, line-of-sight, etc.), a WTRU may be configured to measure Error Vector Magnitude (EVM) over dedicated RSs to determine the level of linearity/nonlinearity of the transmitted/received signal. The WTRU may perform the EVM measurement after equalization and mitigation of other RF distortions (e.g., phase noise) and determine the degree of linearity/nonlinearity of the signal based on the level of the measured EVM.

A WTRU may estimate if PA bias was changed and adapt accordingly.

A WTRU may be configured with a pattern of linearity RS for DPD training and/or DPOD adjustment (e.g., by semi-static or RRC signaling), where the WTRU successively reports changes to an observed linearity state metric. For each linearity RS training pattern, the WTRU may be configured with associated RS resources to measure associated measurement gaps, where a measurement gap is a period between linearity RSs in the pattern, and/or an expected number of RS occasions per pattern. The WTRU may receive a MAC CE to activate or deactivate reporting associated with a linearity RS training pattern. The WTRU may alternatively assume that a linearity RS training pattern is active until deactivated by semi-static or RRC signaling.

A WTRU may be configured to monitor one or more linearity RSs (e.g., RS occasions that are part of a linearity RS training pattern). The WTRU may determine that a serving cell's PA is in a non-linear state upon detection of a linearity state metric change (e.g., a change in power level, phase, or amplitude) larger than a configured or predetermined threshold. The WTRU may determine the linearity state metric change from: measuring the difference in linearity state between linearity RS occasions, the difference in linearity state between the modulated RS and associated intermodulation by products, and/or measured channel conditions (e.g., RSRP measured less than a threshold).

In an embodiment, a WTRU may receive first and second reference signals and determine a non-linearity metric from comparing the first and second reference signals, as discussed below. The WTRU may determine that the serving cell's PA is in a non-linear state upon measuring a non-linearity metric difference between the first and second RS occasions larger or lower than a threshold. The non-linearity metric is discussed below.

In an embodiment, a WTRU may determine that the serving cell's PA is in a non-linear state upon reception of a DL signal associated with an NES state, including one or more of the following: an SSB or a subset of SSBs (e.g., a stripped down SSB or a PSS-only SSB), reception of a periodic presence DL signal associated with an NES state (e.g., a reference signal), or measuring channel conditions associated with the DL signal below or above a configured threshold.

A WTRU may infer NES mode implicitly and may apply DPOD.

A WTRU may determine whether to perform or to activate DPOD methods based on detecting a linearity state metric change larger than a threshold or detecting that the serving cell is in a non-linear state. The WTRU may report linearity state changes and/or provide related assistance information, as discussed below, upon detecting a linearity state metric change larger than a threshold. For a WTRU capable of DPOD, the WTRU may perform or activate DPOD methods upon determining that the serving cell is a given availability state (e.g., after receiving EVM requirements).

A WTRU may determine that a cell is in a given availability state upon detecting a linearity state metric change larger than a threshold, determining that the serving cell's PA is in a non-linear state, and/or receiving an indication (e.g., MAC CE or RRC re-configuration) associated with activating a linearity RS training pattern or a linearity RS resource.

A WTRU may activate or deactivate reporting of linearity state associated measurements upon detecting a linearity state metric change larger than a threshold or detecting the serving cell is in a non-linear state.

One or more network energy saving (NES) operation modes may be used, where a first NES operation mode may be a “normal mode” and a second NES operation mode may be an “energy saving mode”. In the first NES operation mode (e.g., normal mode), a gNB may perform transmission/reception without one or more network energy saving schemes. In the second NES operation mode (e.g., energy saving mode), a gNB may perform transmission/reception with at least one network energy saving scheme.

Network energy saving (NES) procedures may include at least one of following but not limited to: ON/OFF transmission or reception at gNB (e.g., turn ON/OFF of one or more downlink transmission for all or a subset of time/frequency resources); transmission power level change in dynamic or semi-static manner; ON/OFF all or a subset of antenna ports at a gNB; relaxing (e.g., RF, EVM, etc.) requirements of transmit/receive antennas at a gNB; and offloading WTRUs to neighboring cells (or gNBs).

Based on which subset of NES procedure(s) to use, to determine, or to configure to use may result in determining a different NES operation mode. For example, a first subset of NES procedures may be used when a first NES operation mode is used, configured, or determined, a second subset of NES procedures may be used when a second NES operation mode is used;, and a third subset of NES procedures may be used when a third NES operation mode is used, where the subset may include an empty set.

NES operation modes may be interchangeably used with network availability states, NES states, NES status, NES configurations, NES modes, and NES cases.

A WTRU may be indicated or informed about an NES operation mode from a gNB. The WTRU may assume, expect, or determine one or more of following: EVM (error vector magnitude) level, wherein error types include amplitude, frequency/phase, timing, and IQ offset (e.g., EVM level may be better when a WTRU is in a first NES operation mode (e.g., normal mode) than the EVM level when the WTRU is in a second NES operation mode (e.g., energy saving mode); non-linearity level of a power amp at the gNB transmitter; coverage of a signal (e.g., SINR level); distortion level of the signal transmitted from the gNB; and pre-distortion procedure used at the gNB (e.g., a first pre-distortion procedure may be used when a gNB is in a first NES operation mode and a second pre-distortion procedure may be used when the gNB is in a second NES operation mode).

Herein, non-linearity level, linearity level, non-linearity quality, linearity quality, non-linearity status, and linearity status may be interchangeably used.

A WTRU may be configured, indicated, or determined to report one or more of non-linearity status related information (NLS), wherein the NLS may include one or more following: level of one or more error types (e.g., amplitude, frequency/phase, timing, and IQ offset); distortion level of signal received from the gNB; whether the WTRU meets indicated, determined, or configured EVM requirement level; DPoD procedure used at the WTRU; WTRU capability of NLS measurement and/or DPoD; and EVM level, wherein the EVM level may be a current EVM level, most recent EVM level measured, target EVM level, EVM level before DPoD, or EVM level after DPoD. The WTRU may provide feedback indicating whether or not it can meet the EVM requirement (e.g., after receiving the linearity RS).

A WTRU may report, or be triggered to report, one or more of NLS when one or more of following conditions are met.

A condition may be a determined NES operation mode. For example, when a WTRU is configured, indicated, or determined to operate in a first NES mode (e.g., normal mode), the WTRU may not report NLS. If the WTRU is configured, indicated, or determined to operate in a second mode (e.g., energy saving mode), the WTRU may report NLS.

A condition may be that a level of non-linearity of the received signal is below a threshold. The level of non-linearity of the received signal may be determined based on one or more of following. The level of non-linearity of the received signal may be determined based on whether an EVM level is below or above a threshold. The threshold may be an EVM requirement determined or configured by a gNB. The level of non-linearity of the received signal may be determined based on an energy level detected in a certain resource being below/above a threshold. The energy level may be referred to as at least one of: out-of-band emission, out-of-band leakage, adjacent carrier leakage, adjacent frequency resource leakage, adjacent RB leakage, and unwanted band emission. The resource for the energy level detection or measurement may be at least one of following: a frequency resource within an active BWP; a frequency resource next to the active BWP (e.g., next to the edge of the active BWP); a frequency resource next to the carrier (e.g., next to the edge of the carrier); and a guard band used, configured, or determined for the scheduled resource, associated BWP, and/or associated carrier. If the energy level detected in the certain resource is above a threshold, a WTRU may assume that the non-linearity level at a gNB may need to be fixed. The level of non-linearity of the received signal may be determined based on an error level for a specific modulation order. For example, a WTRU may track or measure an error level of each modulation order (e.g., QPSK, 16 QAM, 64 QAM) and if the error level for a specific modulation order (e.g., a higher modulation order, like 64 QAM, 256 QAM) is higher than a threshold (or larger than that for a lower modulation order), then the WTRU may report it. The error level for a specific modulation order may be a number of HARQ NACK for PDSCH/PUSCH transmissions associated with the specific modulation order for a certain time window.

A condition may be the number of consecutive NACK for PDSCH and/or PUSCH being below or above a threshold.

A condition may be the one or more of thresholds mentioned herein may be predetermined, (pre-)configured, or indicated by a gNB.

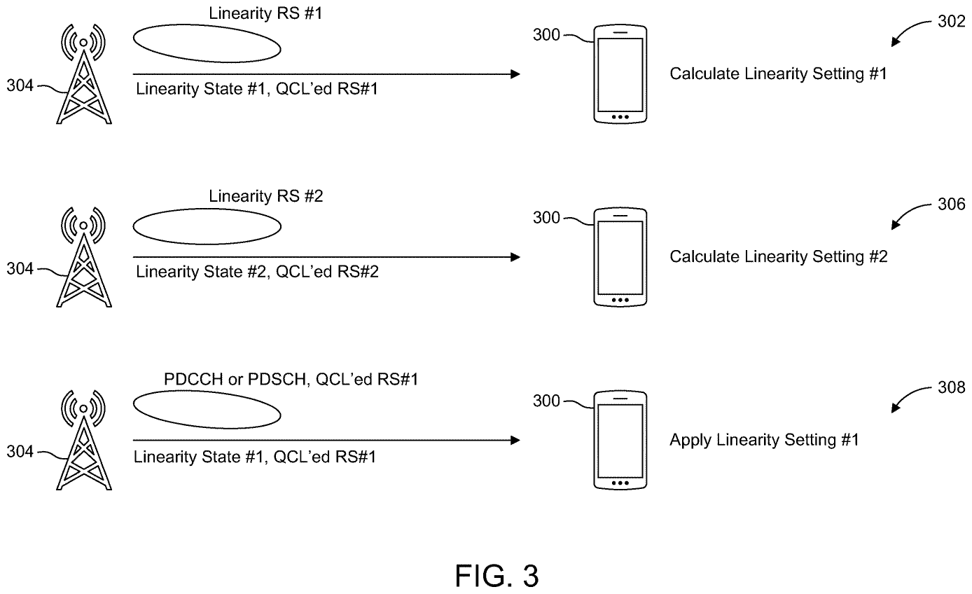

FIG. 3 shows an example of a WTRU 300, at or during a relative time 302, receiving a reference signal (RS) from a gNB (or other WTRU such as another base station or a wireless network access point) 304 and adjusting a configuration of a receiver that is onboard the WTRU or that is otherwise part of a wireless network to compensate for distortions measured on the reference signal.

Still at or during the relative time 302, the WTRU 300 may receive a configuration and/or indication for a first reference signal (linearity reference signal (RS) #1) and associated first linearity state (Linearity state #1). The configuration may comprise a first quasi-collocated (QCL'ed) RS (e.g., CSI-RS or SSB) (QCL'ed RS #1). The WTRU 300 may receive the first linearity RS and calculate, or otherwise determine, a first linearity setting (linearity setting #1) applicable to the first linearity state (Linearity state #1) and QCL'ed RS/SSB (QCL'ed RS #1). The linearity setting may correspond to, for example, parameters of a DPOD module onboard the WTRU 300.

At or during a relative time 306, the WTRU 300 may receive a configuration for a second reference signal (Linearity RS #2) and associated second linearity state (Linearity state #2) and second QCL'ed RS/SSB or TCI state (QCL'ed RS #2). The WTRU 300 may receive the second linearity RS and calculate, or otherwise determine, a second linearity setting (linearity setting #2) applicable to second the linearity state (linearity state #2) and QCL'ed RS/SSB (QCL'ed RS #2). The WTRU 300 may report whether a minimum performance requirement is met with one or both of the (first and/or second) linearity settings.

At or during a relative time 308, the WTRU 300 may receive an indication of the linearity state and QCL'ed RS/SSB (e.g., QCL'ed RS #1) applicable to a PDCCH or PDSCH reception, for example, from an indicated generalized TCI state that comprises a linearity state, or from an indicated TCI state and a linearity state indicated by a DCI or MAC CE. The WTRU 300 may receive information over a PDCCH or PDSCH using the first or (second) linearity setting if the indication is for the first (or second) linearity state and QCL'ed RS/SSB RS #1 (or QCL'ed RS/SSB RS #2), and may apply the linearity setting (e.g., the first linearity setting #1 and/or the second linearity setting #2).

In an embodiment, the WTRU 300 may receive a reference signal (linearity RS) and determine a non-linearity metric from the reference signal. The WTRU 300 may use such linearity RS to estimate a power level of intermodulation byproducts and/or to provide feedback to a gNB for DPD purposes. This may have the benefit of assisting the gNB in adjusting its digital predistortion parameters and/or to inform the gNB as to what level of non-linearity is acceptable for the WTRU 300. The WTRU 300 may report the value of the non-linearity metric, possibly under a condition that the metric is lower (or higher) than a configured threshold. The WTRU 300 may be configured with a linearity RS and an associated measurement resource, per beam, per group of DL or UL spatial elements, per BWP, and/or per TRP.

Still referring to FIG. 3, the WTRU 300 may report the amplitude, power, and/or phase difference between the received linearity RS and associated intermodulation byproducts. The WTRU 300 may be configured with a granularity of reporting such difference. For example, the WTRU 300 may be configured with a number of bits to report the feedback, and a mapping between each codebook entry and the difference between the linearity RS and 3^{rd}-order intermodulation byproducts. For example, for a codebook of a 3-bit size, the WTRU 300 may indicate to the gNB 304 that: 000 corresponds to a difference of x dB between the modulated linearity RS and the 3^{rd}-order modulation byproduct, 001 corresponds to a difference of y dB between the modulated linearity RS and the 3rd-order modulation byproduct, and so on. Such a mapping may instead be specified or determined based on a configured step size in dB.

In an embodiment, the WTRU 300 may receive first and second reference signals (e.g., RS #1 and RS #2) and determine a non-linearity metric from comparing the first and second reference signals. The non-linearity metric may include at least one of the following: a phase difference between the first and second RS or a function thereof (e.g., a variance); error vector magnitude (EVM); or an indication of whether a linearity metric (e.g., the level of intermodulation by products of a certain order) for the second RS is higher than for the first RS and/or the quantity of the difference.

The WTRU 300 may report the linearity state for each linearity RS in the pattern (e.g., including power level, amplitude, and/or phase difference between the RS and the byproducts). Alternatively, the WTRU 300 may report the power level, amplitude, and/or phase difference only for the linearity RS, where the difference is measured as the difference in linearity state between the past two consecutively received linearity RSs.

The WTRU 300 may receive a configuration and/or indication for a first and a second linearity RS. The WTRU 300 may determine a non-linearity metric from the received first and second linearity RS. For example, the non-linearity metric may be: a phase and/or amplitude difference between the first and second linearity RS or variance thereof; an EVM difference; a model-specific parameters (e.g., memory polynomial parameters); or measurements relating to the difference in power or amplitude levels measured at the frequencies of the linearity RS and associated intermodulation byproducts. The WTRU 300 may receive two signals which may allow isolating the effect of linearity change at transmitter only. The WTRU 300 may transmit a report of non-linearity metric (e.g., RRC measurement report and/or assistance information for DPD setting), possibly, under a condition that a non-linearity metric is higher than a configured threshold.

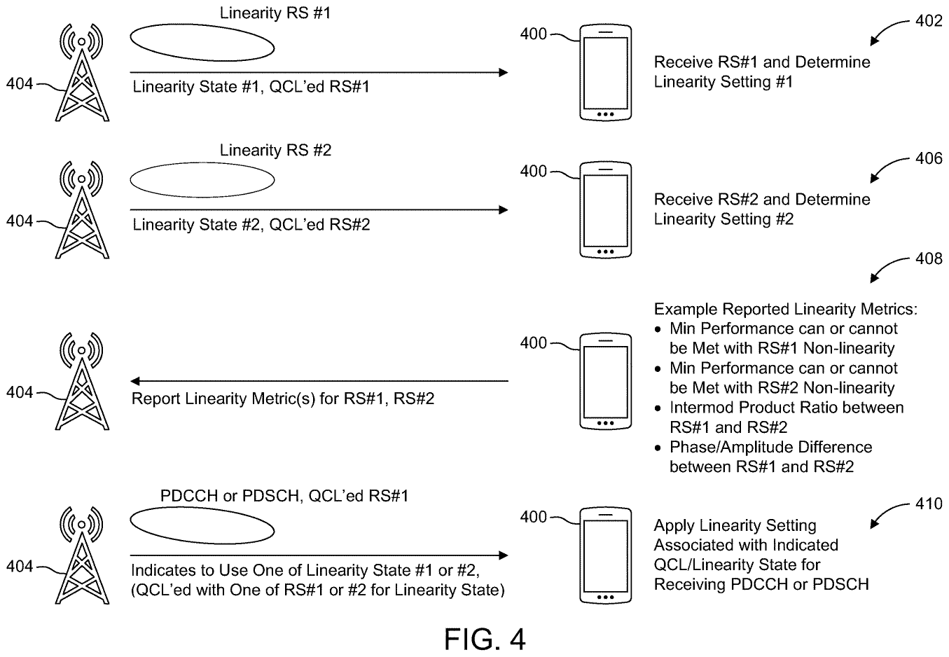

FIG. 4 shows an example of a WTRU 400, at or during a relative time 402, receiving a reference signal (RS) from a gNB (or other WTRU such as another base station or a wireless network access point) 404 and adjusting a configuration of a receiver that is onboard the WTRU or that is otherwise part of a wireless network to compensate for distortions measured on the reference signal, where the distortions may be a result of the gNB (or other transmitter) reducing the power of one or more power amplifiers of the gNB.

Still at or during the relative time 402, the WTRU 400 may receive a configuration and/or indication for a first reference signal (linearity reference signal (RS) #1) and associated first linearity state (Linearity state #1). The configuration may comprise a first quasi-colocated (QCL'ed) RS (e.g., CSI-RS or SSB) (QCL'ed RS #1). The WTRU 400 may receive the first linearity RS and determine, or otherwise calculate, a first linearity setting (linearity setting #1) applicable to the first linearity state (Linearity state #1) and QCL'ed RS/SSB (QCL'ed RS #1). The linearity setting may correspond to, for example parameters of a DPOD module onboard the WTRU 400.

At or during a relative time 406, the WTRU 400 may receive a configuration for a second reference signal (Linearity RS #2) and associated second linearity state (Linearity state #2) and second QCL'ed RS/SSB or TCI state (QCL'ed RS #2). The WTRU 400 may receive the second linearity RS and determine, or otherwise calculate, a second linearity setting (linearity setting #2) applicable to second the linearity state (linearity state #2) and QCL'ed RS/SSB (QCL'ed RS #2).

At or during a relative time 408, the WTRU 400 may determine or otherwise calculate, and report to the gNB 404 or other device in the wireless network, linearity metrics related to one or more of the linearity states (e.g., linearity state #1 and/or linearity state #2) and/or related to one or more of the reference signals (e.g., RS #1, RS #2, QCL'ed RS #1, and/or QCL'ed RS #2). Examples of such linearity metrics include, but are not limited to: an indication as to whether a minimum level of performance can be met with one or more of the reference signals (e.g., RS #1 and/or RS #2) considering the level of non-linearity of each of the one or more reference signals; a ratio of intermodulation products related to two or more reference signals (e.g., RS #1 and RS #2); and a phase difference and/or an amplitude difference between two or more reference signals (e.g., RS #1 and RS #2).

At or during a relative time 410, the WTRU 400 may receive an indication of a linearity state (e.g., linearity state #1 or linearity state #2, which can be QCL'ed RS #1 or QCL'ed RS #2), and the WTRU may configure itself to apply a linearity setting (e.g., linearity setting #1 or linearity setting #2) associated with the indicated QCL and/or the linearity state, for example, to receive information over PDCCH or PDSCH. For example, the WTRU 400 may receive the indication of the linearity state from an indicated generalized TCI state that comprises a linearity state, or from an indicated TCI state and a linearity state indicated by a DCI or MAC CE. The WTRU 400 may receive information over a PDCCH or PDSCH using the first or (second) linearity setting if the indication is for the first (or second) linearity state and QCL'ed RS/SSB RS #1 (or QCL'ed RS/SSB RS #2), and may apply the linearity setting (e.g., the first linearity setting #1 and/or the second linearity setting #2).

In an embodiment, the WTRU 400 may receive a reference signal (linearity RS) and determine a non-linearity metric from the reference signal. The WTRU 400 may use such linearity RS to estimate a power level of intermodulation byproducts and/or to provide feedback to the gNB 404 for DPD purposes. This may have the benefit of assisting the gNB 404 in adjusting its digital predistortion parameters and/or to inform the gNB as to what level of non-linearity is acceptable for the WTRU 400. The WTRU 400 may report the value of the non-linearity metric, possibly under a condition that the metric is lower (or higher) than a configured threshold. The WTRU 400 may be configured with a linearity RS and an associated measurement resource, per beam, per group of DL or UL spatial elements, per BWP, and/or per TRP.

Still referring to FIG. 4, the WTRU 400 may report the amplitude, power, and/or phase difference between the received linearity RS and associated intermodulation byproducts. The WTRU 400 may be configured with a granularity of reporting such difference. For example, the WTRU 400 may be configured with a number of bits to report the feedback, and a mapping between each codebook entry and the difference between the linearity RS and 3^{rd}-order intermodulation byproducts. For example, for a codebook of a 3-bit size, the WTRU 400 may indicate to the gNB 404 that: 000 corresponds to a difference of x dB between the modulated linearity RS and the 3^{rd}-order modulation byproduct, 001 corresponds to a difference of y dB between the modulated linearity RS and the 3^{rd}-order modulation byproduct, and so on. Such a mapping may instead be specified or determined based on a configured step size in dB.

In an embodiment, the WTRU 400 may receive first and second reference signals (e.g., RS #1 and RS #2) and determine a non-linearity metric from comparing the first and second reference signals. The non-linearity metric may include at least one of the following: a phase difference between the first and second RS or a function thereof (e.g., a variance); error vector magnitude (EVM); or an indication of whether a linearity metric (e.g., the level of intermodulation by products of a certain order) for the second RS is higher than for the first RS and/or the quantity of the difference.

The WTRU 400 may report the linearity state for each linearity RS in the pattern (e.g., including power level, amplitude, and/or phase difference between the RS and the byproducts). Alternatively, the WTRU 400 may report the power level, amplitude, and/or phase difference only for the linearity RS, where the difference is measured as the difference in linearity state between the past two consecutively received linearity RSs.

The WTRU 400 may receive a configuration and/or indication for a first and a second linearity RS. The WTRU 400 may determine a non-linearity metric from the received first and second linearity RS. For example, the non-linearity metric may be: a phase and/or amplitude difference between the first and second linearity RS or variance thereof; an EVM difference; a model-specific parameters (e.g., memory polynomial parameters); or measurements relating to the difference in power or amplitude levels measured at the frequencies of the linearity RS and associated intermodulation byproducts. The WTRU 400 may receive two signals which may allow isolating the effect of linearity change at transmitter only. The WTRU 400 may transmit a report of non-linearity metric (e.g., RRC measurement report and/or assistance information for DPD setting), possibly, under a condition that a non-linearity metric is higher than a configured threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving configuration information including two or more linearity states each associated with a reference signal (RS);
receiving one or more RSs and determining a linearity setting for each of the received one or more RSs;
reporting one or more non-linearity metrics relating to measurements of the received one or more RSs;
receiving an indication to use a first linearity state for receiving a downlink (DL) transmission; and
receiving the DL transmission using the determined linearity setting for the RS associated with the indicated first linearity state.

2. The method of claim 1, wherein the DL transmission comprises a physical downlink control channel (PDCCH) transmission or a physical downlink shared channel (PDSCH) transmission.

3. The method of claim 1, wherein the one or more non-linearity metrics comprise an indication of whether a minimum performance can be met with a determined non-linearity setting of the received one or more RS.

4. The method of claim 1, wherein the one or more non-linearity metrics comprise an intermodulation product ratio between measurements of at least two received RSs, a phase between the measurements of the at least two received RSs, or an amplitude difference between the measurements of the at least two received RSs.

5. The method of claim 1, wherein the linearity setting corresponds to at least one parameter used for digital post-distortion.

6. The method of claim 1, wherein at least two of the received one or more RSs are quasi-located RSs.

7. The method of claim 1, further comprising determining the one or more linearity metrics by taking at least one measurement of the received one or more RSs.

8. The method of claim 1, further comprising transmitting feedback to a base station related to a parameter for use by the base station to pre-compensate, digitally, for distortion caused by a power amplifier.

9. The method of claim 1, further comprising transmitting feedback to a base station, the feedback related to a digital predistortion parameter for signal non-linearity.

10. A wireless transmit/receive unit (WTRU) comprising:
circuitry configured to receive configuration information including two or more linearity states each associated with a reference signal (RS);
circuitry configured to receive one or more RSs and determine a linearity setting for each of the received one or more RSs;
circuitry configured to report one or more non-linearity metrics relating to measurements of the received one or more RSs;
circuitry configured to receive an indication to use a first linearity state for receiving a downlink (DL) transmission; and
circuitry configured to receive the DL transmission using the determined linearity setting for the RS associated with the indicated first linearity state.

11. The WTRU of claim 10, wherein the DL transmission comprises a physical downlink control channel (PDCCH) transmission or a physical downlink shared channel (PDSCH) transmission.

12. The WTRU of claim 10, wherein the one or more non-linearity metrics comprise an indication of whether a minimum performance can be met with a determined non-linearity setting of the received one or more RSs.

13. The WTRU of claim 10, wherein the one or more non-linearity metrics comprise an intermodulation product ratio between measurements of at least two received RSs, a phase between the measurements of the at least two received RSs, or an amplitude difference between the measurements of the at least two received RSs.

14. The WTRU of claim 10, wherein the linearity setting corresponds to at least one parameter used for digital post-distortion.

15. The WTRU of claim 10, wherein at least two of the received one or more RSs comprise quasi-located RSs.

16. The WTRU of claim 10, further comprising circuitry configured to determine the one or more linearity metrics by taking at least one measurement of the received one or more RSs.

17. The WTRU of claim 10, further comprising circuitry configured to transmit feedback to a base station, the feedback related to a parameter for use by the base station to pre-compensate, digitally, for distortion caused by a power amplifier.

18. The WTRU of claim 10, further comprising circuitry configured to transmit feedback to a base station, the feedback related to a digital predistortion parameter.

19. (canceled)

20. (canceled)

21. The WTRU of claim 11, further comprising circuitry configured to train a receiver of the WTRU to compensate for signal non-linearity.

22. The method of claim 1, further comprising training a receiver of the WTRU to compensate for signal non-linearity.
